(19) United States
(12) Patent Application Publication
(10) Pub. No.: US 2008/0051076 A1
(43) Pub. Date: Feb. 28, 2008

(54) System And Method For Mobile Device Application Management

(76) Inventors: John O'Shaughnessy, Brunton-Wiltshire (GB); Jeroen Herman Mol, Den Dolder (NL); Pieter Bastiaan Leezenberg, San Francisco, CA (US)

Correspondence Address: ST. ONGE STEWARD JOHNSTON & REENS LLC, 986 Bedford Street, Stamford, CT, 06905-5619, US

(21) Appl. No.: 11/844,849

(22) Filed: Aug. 24, 2007

Related U.S. Application Data
(63) Continuation-in-part of application No. 11/509,994, filed on Aug. 25, 2006.

(51) Int. Cl. H04M 3/00

(52) U.S. Cl. 455/419

(57) ABSTRACT

A system for managing mobile electronic devices in a network, including a plurality of mobile electronic devices, a directory service including user data pertaining to one or more users of the plurality of mobile electronic devices, and a device manager for receiving the user data and determining a group of the users and at least one privilege applicable the group based on the user data and data from at least one other source, wherein the device managers sends at least one mobile application to one or more of the plurality of mobile electronic devices based on the privilege, and wherein the device manager includes software for determining a status of the at least one mobile application for each of the one or more mobile electronic devices.

### CROSS-REFERENCE TO RELATED APPLICATIONS

This is a continuation-in-part of a U.S. patent application Ser. No. 11/509,994, filed on Aug. 25, 2006.

### FIELD OF THE INVENTION

The invention relates generally to mobile electronic devices, and more specifically to a system and method for managing applications on mobile electronic devices.

### BACKGROUND OF THE INVENTION

Mobile electronic devices, such as the Blackberry® developed by Research in Motion Limited (RIM) and others including Symbian devices, Windows Mobile devices, and Palm devices, have become common place in a many industries and professions. Organizations generally invest in mobile devices and the associated infrastructure to increase the accessibility and effectiveness of their employees. It is therefore important that measures are taken to ensure that such mobile devices are being deployed cost-effectively and in a way that supports business goals.

Mobile electronic devices generally including any number of software applications. Such applications must be loaded on to the mobile electronic device and updated periodically. In a large organization having hundreds or thousands of mobile electronic devices, the implementation of new software or updating of existing software may be very time consuming and complicated. For example, U.S. Patent Application Publication 2006/0046717 discloses a method for providing wireless device management. The method includes a service provider receiving a request for wireless devices with specified pre-loaded software, loading the software on each individual device, delivering the devices and connecting the devices to a network. Should any changes be necessary to the pre-loaded software, the organization must send a request to the service provider. The request is evaluated by a technical specialist of the service provider and a team meets to evaluate the feasibility of the request. The service provider then contacts the service receiver to review the feasibility findings. If the request is approved, the service provider develops a configuration change and drafts a means for delivering the change.

Individual users of mobile electronic devices may also download, install or uninstall software applications on their particular device. Use of applications not authorized by the organization may negatively affect the device, create software compatibility issues and/or be in conflict with IT policies or regulatory requirements in the organization. Likewise, the erroneous or intentional deletion of software applications from an individual's mobile electronic device may inhibit the usefulness of the device.

It is therefore desired to provide an improved system and method for managing policies and applications on mobile electronic devices.

### SUMMARY OF THE INVENTION

Accordingly, it is an object of the present invention to provide a system and method for the configuration and future change of information technology policies to wireless devices.

It is a further object of the present invention to provide a system for managing applications on mobile electronic devices which allows an organization to deploy software to one or more groups of mobile devices.

It is a further object to provide a system for managing applications on mobile electronic devices which provides for the targeted removal of software from one or more groups of mobile devices. The software may be custom built applications, third party applications, application data and/or configurations.

It is a further object to provide a system for managing applications on mobile electronic devices able to configure, and associate application privileges with one or more mobile devices or groups of mobile devices and update, load, and/or remove software accordingly.

These and other objectives are achieved by providing a system for managing mobile electronic devices in a network including a plurality of mobile electronic devices, a directory service including user data pertaining to one or more users of the plurality of mobile electronic devices, and a device manager. The device manager receives the user data and determines a group of the users and at least one privilege applicable to the group based on the user data and data from at least one other source. The device manager may further send at least one mobile application to one or more of the plurality of mobile electronic devices and/or implement at least one IT policy based on the at least one privilege. The device manager also includes software for determining a status of the mobile application for each of the one or more mobile electronic devices.

In some embodiments, the status is indicative of the mobile application having been sent to the device, the mobile application having been received by the device, or the mobile application having been installed. The status may further be indicative of a failure in sending the mobile application and/or installing the mobile application. In further embodiments, the device manager sends the mobile application to a first group of the mobile electronic devices pertaining to a first group of the users, and subsequently sends the mobile application to a second group of the mobile electronic devices pertaining to a second group of users, and so on to any number of groups.

Further provided is a system for managing mobile electronic devices in a network including a plurality of mobile electronic devices, a directory service including user data pertaining to one or more users of the plurality of mobile electronic devices, a policy database including a plurality of policies pertaining to the mobile electronic devices, a device manager database including data indicative of associations between the user data and the policies for one or more groups of the users, and a device manager for determining one or more policies for at least one group of the users based on the plurality of policies and the associations and implementing the one or more policies on at least one group of the plurality of mobile electronic devices. The device manager includes a user interface for providing access to the user data, policies and/or device manager database. In some embodiments, the system includes an enterprise mobility server wherein the enterprise mobility server includes the policy database. In further embodiments, the device manager database includes one or more application assignments and the device manager further determines one or more application assignments for the group of users and sends at least one mobile application to the group of mobile electronic devices based on the one or more application assignments.

Other objects are achieved by providing a system for managing mobile electronic devices in a network, including a plurality of mobile electronic devices, at least one network processor, and directory service software executing on the at least one network processor for providing user data pertaining to users of the plurality of mobile electronic devices. The system further includes at least one mobility server in communication with the at least one network processor, and device management software executing on the at least one mobility server for receiving the user data and sending at least one mobile application to one or more of the plurality of mobile electronic devices.

Further provided is a system for managing mobile electronic devices in a network, including a plurality of mobile electronic devices, each of the mobile electronic devices including device agent software for providing device data, and at least one processor. The system includes directory service software executing on the at least one processor for providing user data pertaining to users of the plurality of mobile electronic devices, and device management software executing on the at least one processor for receiving the user data and sending at least one device policy to one or more of the plurality of mobile electronic devices.

Further provided is a method of managing mobile electronic devices in a network, including the steps of receiving user data from a directory service, the user data pertaining to at least one mobile electronic device user, determining mobile application privileges for the at least one user, determining a device status of at least one mobile electronic device corresponding to the at least one user, and modifying or upgrading a previously installed application, deleting an application or sending a new application to the at least one mobile electronic device based on the mobile application privileges and the device status.

Other objects, features and advantages according to the present invention will become apparent from the following detailed description of certain advantageous embodiments when read in conjunction with the accompanying drawings in which the same components are identified by the same reference numerals.

### BRIEF DESCRIPTION OF THE DRAWINGS

FIG. 1 is schematic diagram of a system according to the present invention.

FIG. 2 is another schematic diagram of the system shown in FIG. 1.

FIG. 3 is another schematic diagram of the system shown in FIG. 1.

FIG. 4 is method for managing applications on mobile electronic devices employable by the system shown in FIGS. 1-3.

FIGS. 5A and 5B illustrate an exemplary user interface for a system administrator generated by the system shown in FIGS. 1-3.

FIGS. 6A and 6B illustrate another exemplary user interface for a system administrator generated by the system shown in FIGS. 1-3.

FIGS. 7A and 7B illustrate another exemplary user interface for a system administrator generated by the system shown in FIGS. 1-3.

### DETAILED DESCRIPTION OF THE INVENTION

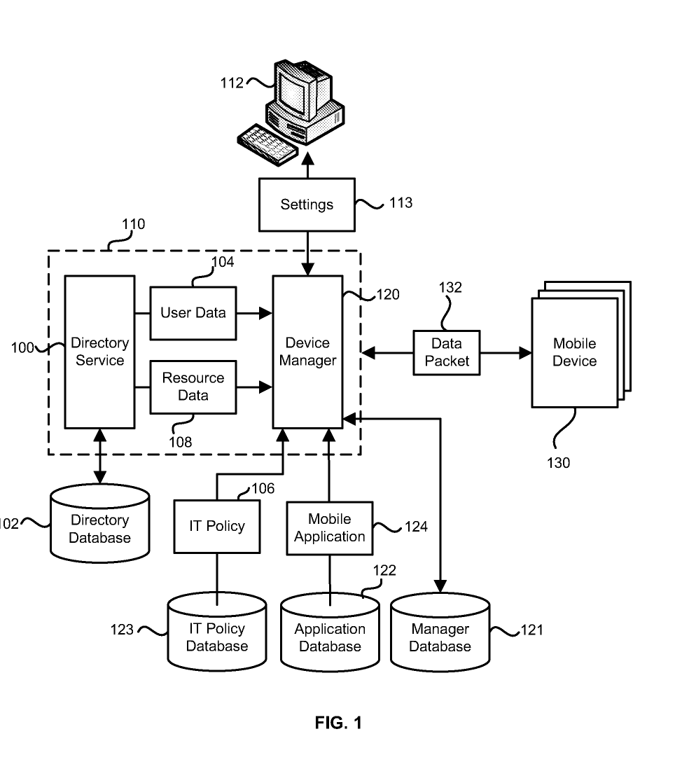

FIG. 1 shows a system for managing applications on mobile electronic devices according to the present invention. The system includes a directory service 100. The directory service 100 may be embodied in software, hardware or a combination of both. For example, the directory service 100 may be a software application that stores and structures information about an organization and/or its computer network's resources (e.g., users, groups, computers, printers, storage, etc). In some embodiments, the directory service 100 is an implementation of Lightweight Directory Access Protocol (“LDAP”) such as Microsoft's Active Directory or any other LDAP directory service. The information, e.g., user data, resource data, etc., is stored in one or more directory databases 102 of the system. The directory service 100 may execute on one or more network processors 110 and/or network servers.

The system includes a plurality of mobile devices 130. The mobile devices 130 may be any mobile devices, such as mobile phones, personal digital assistants (“PDA's”), smart phones, handhelds, PocketPC's, or notebook computers. For example, the mobile devices 130 may be Blackberry® mobile devices, developed by Research in Motion Limited (“RIM”), Symbian devices (e.g., Nokia), Windows Mobile devices (e.g., Motorola), or Palm devices.

The system further includes at least one device manager 120 for managing the plurality of mobile devices 130 and users thereof based on data obtained from the directory service 100 and one or more other sources. The device manager 120 may be embodied in hardware, software or a combination of both. For example, the device manager 120 may be a server, and/or software executing on a server. The device manager 120 may further include device management software for mobile device and application management and data synchronization to the mobile devices 130.

The system further includes any number of data sources, in addition to the directory service 100, accessible by the device manager 120. One of the sources may be, for example, a database 123 including information technology (“IT”) policies 106. As used herein, IT policies include device specific settings that may be associated with particular users, groups or applications (e.g., camera=true, Bluetooth=true, etc). In the preferable embodiment, the database 123 is included in a mobility server (e.g., Blackberry Enterprise Server) or its associated databases. However, in some other embodiments, the IT policy database may be a separate database or included in a device manager database (e.g., 121) discussed below.

The device manager 120 includes one or more manager databases 121 in communication therewith. The manager database 121 (e.g., MSM database) may include a plurality of custom data, settings and attributes pertaining to mobile devices, device applications (e.g., application assignments), users and groups of users. Application assignments indicate mobile device applications and software that are mandatory or optional (e.g., white listed), or not permitted (e.g., black listed) for a user or group of users. For example, a particular application may be “white listed” or “black listed” for all users, certain groups and/or named individuals. Application assignments are generally stored in the manager database 121, but may also be stored on a mobility server in some embodiments. The manager database 121 preferably also includes abstracts and/or references to some standard data and attributes that are stored in the directory service 100 and the other sources, and data indicative of the associations or relationships between such data and attributes. For example, the device manager 120 may determine a user or device group based on user and/or group data received from the directory service 100. However, a group may alternatively be determined from a combination of data and attributes obtained from the directory service, data obtained from any number of other sources (e.g., one or more mobility servers), and the relationship data stored in the manager database 121. The data necessary to determine such a group and the locations thereof is referenced in the manager database 121 and the particular users in the group are dynamically determined by the device manager 120, e.g., when requested or at a time when an action is necessary for the group.

Similarly, privileges for a group, user and/or device may be determined based on a combination of user/group data received from the directory service 100 and IT policies from the IT policy database 123, together with custom attributes or policies referenced and/or stored in the management database 121 or EMS 126. As discussed below, in the case of single or multiple group membership, the device manager 120 then determines net resultant privileges, including the IT policies and/or application assignments for a user, group or device based on group and application dominance factors or a most or least restrictive policy setting. The system also includes at least one applications database 122 in communication with the device manager 120 including a plurality of mobile applications 124.

The directory service 100 and device manager 120 of the present invention are in communication with one another and/or integrated. The directory service 100 and device manager 120 may be integrated by any means. For example, the device manager 120 may include integration software for communicating with the directory service 100. The system may further include an application programming interface (“API”) software for providing an interface between the directory service 100 and device manager 120. The API may also provide integration with other tools as well, e.g., where the device manager 120 functions are available to another program that the IT or system administrator may run. For example, a large organization may use the API to integrate the system according to the present invention into an existing organization tool such as a tool for deploying and/or managing applications on wired network devices.

The device manager 120 may also include software for monitoring changes in the directory service 100 or the manager database 121. The device manager 120 detects when users are added, removed or modified (e.g., group association modified). For example, a user may be moved from one group to another (e.g., due to a job/department change, a promotion, etc.) requiring a change in IT policies and/or application assignments and usage permissions associated with his/her mobile device. The system may then perform an automatic administrative action based on such an event. The device manager 120 may automatically initiate a push or pull of one or more applications upon a change in the directory service 100 or manager database 121. A report of the change and/or associated action may then be generated. The device manager 120 may also detect device specific events, such as when a particular mobile device 130 is roaming, and perform an administrative action based on the device specific event (e.g., stop browser from working when roaming).

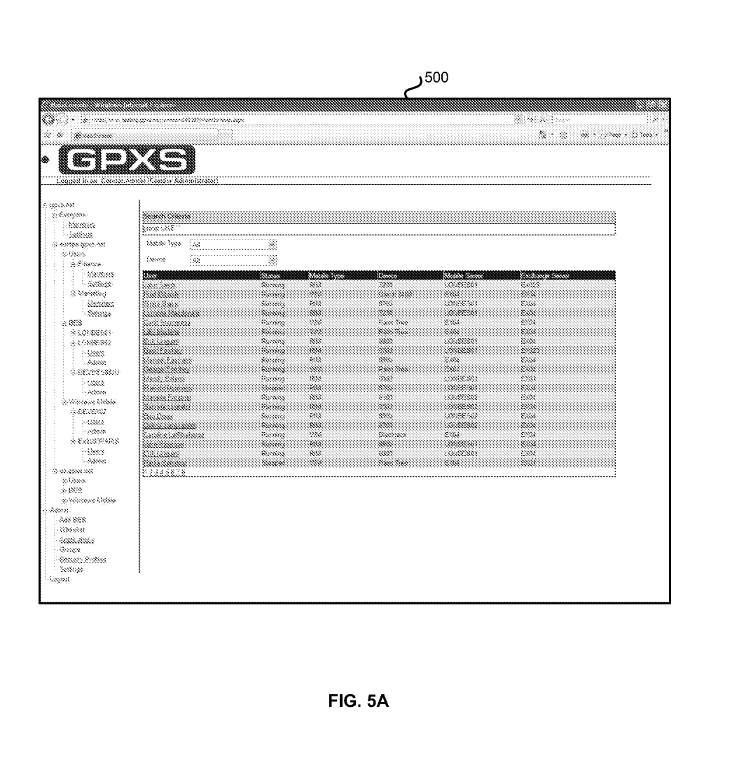

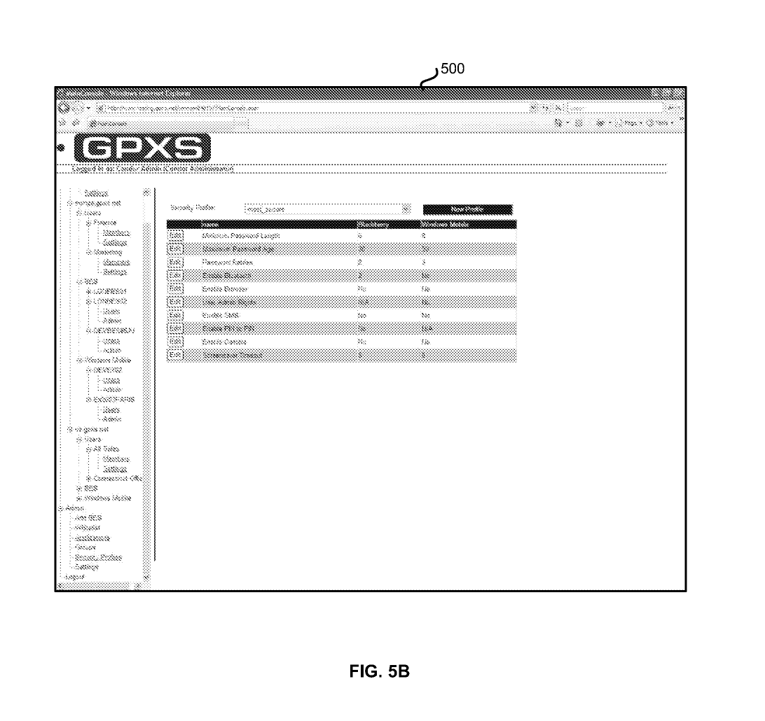

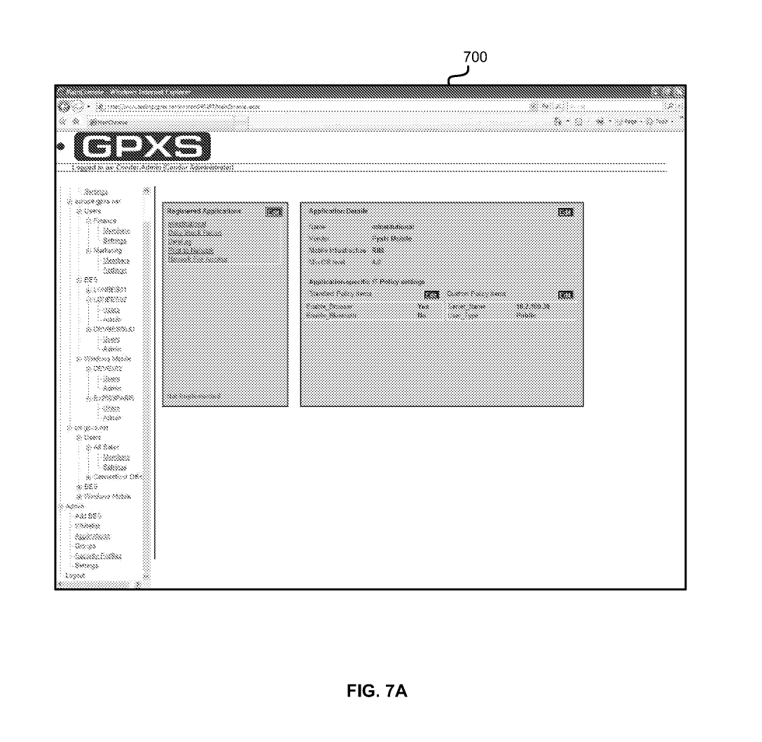

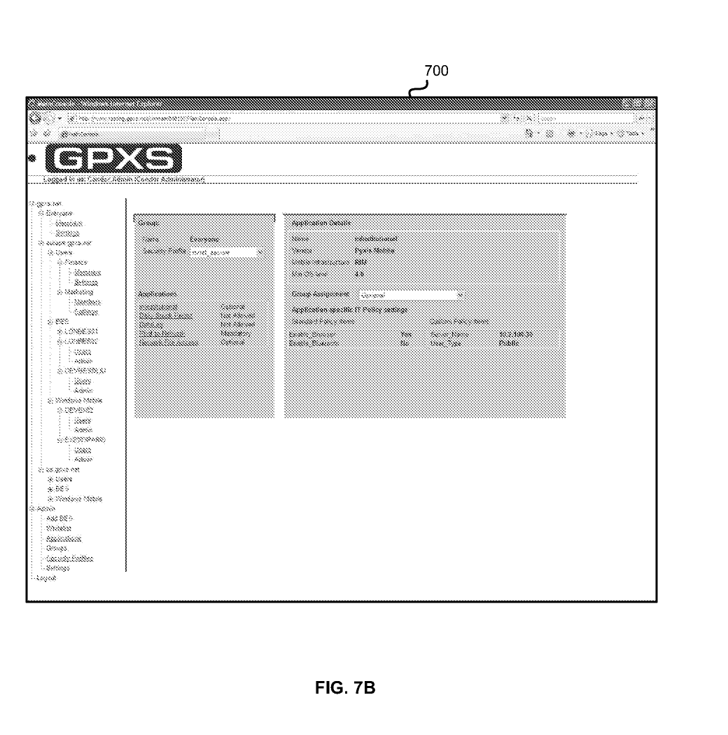

In some embodiments, the system includes user interface and software for providing an administrator with range of system tools (e.g., via a computer 112 or web browser), e.g., using the integration between the device manager 120 and the directory service 100. The user interface allows one or more administrators to provide settings 113 to the device manager 120, such as custom user, group and application settings and/or assignments. For example, an exemplary user interface 700 for an administrator to determine and/or implement application policies for a particular group is shown in FIG. 7B. The user interface may further provide administrators with aggregate views and reporting of information and statuses to the administrator irrespective of the number of different mobility infrastructures employed (see, e.g., FIG. 5A). The system according to the present invention thus provides a single tool and a single user interface or console for managing user groups and a plurality of devices having the same or different mobility infrastructures (e.g., RIM Blackberry, Microsoft, Good Technology, Intellisync, etc.), including devices running different types and versions of operating systems.

Administration via the user interface may be divisible based on various permission levels. For example, some administrators may have full access while others have access to only clusters of administrative rights and functionalities. Administrators may alternatively be granted access to from one particular node downward, e.g., based on geography, domain, group or device infrastructure type, etc. This enables the ability to delegate and/or outsource administrative rights and responsibilities as desired. For example, administrators may be members of administrator groups which are assigned particular permissions. Administrative permissions may be assigned to or associated with individual administrators. The user interface may further provide a plurality of administrator and mobile device user training modules.

As shown in FIG. 1, the device manager 120 may receive information from the directory service 100 pertaining to the organization's users and resources. The user data 104 may include data pertaining to users (e.g., end users) of the mobile devices 130 (e.g., in an organization or corporation). The device manager 120 further receives information such as IT policies, application assignments, and device data from one or more other data sources, such as the management database 121, the IT policy database 123, one or more mobility servers (e.g., EMS 126), mobility server databases and other sources. The device manager 120 maps and stores associations between the data stored the directory service 100 and each of the other sources to determine groups, group and user attributes, and net resultant privileges including IT policies and application assignments.

The device manager 120 may use the information obtained from the directory service 100 and other sources to provide data 132, instructions, applications, and/or IT policies to a plurality of mobile devices 130. The device manager 120 may further implement or enforce the organization's IT policies 106 on the mobile devices 130.

Any number of groups or communities may be registered by the device manager 120, e.g., for the purposes of managing mobile devices, mobile device users, mobile application software, mobile data and mobile IT policies. A group may include a directory service group (e.g., “sales group”). A group may also be a query group that overlaps data from the directory service 100 and one or more other data locations or sources. For example, an administrator may create a query group such as “Blackberry 8100 users that are in sales,” that overlaps data from the sales group obtained from the directory service 100 and data concerning Blackberry 8100 users obtained from a mobility server (e.g., EMS 126) or database thereof. However, the device manager 120 treats all groups equally regardless of how their membership is determined. For example, a group defined simply by a group of users in the directory service 100 is treated identical in operation as a query group. As such, the present invention provides an abstraction layer over multiple mobility infrastructures, device types, applications and sources of user data and a unified mechanism for managing mobility.

In some embodiments, each group includes one particular type of device 130 and/or mobility infrastructure. However, in some embodiments groups configured in the directory service 100 may include users of devices 130 having different mobility infrastructures. When implementing an application deployment or policy to a group, the device manager 120 may determine the particular infrastructure(s) and execute infrastructure specific rules if necessary.

The system according to the present invention may create different layers of abstraction for privileges (e.g., IT policies and/or application assignments). This is useful, for example, to accommodate directory groups in which users have or may have mobile devices with different mobility infrastructures. For example, the system may define a plurality of security profiles or levels (e.g., 1, 2, 3) that may be assigned or associated with different groups. A “sale group” may be assigned a security level 1 indicating that the sales group has the most secure level of security. However, various members of the sales group may have different mobile device types (e.g., Blackberry, Windows Mobile, etc) and such different device types may have different hardware, software and infrastructure features that require at least some unique IT policies. Therefore security level 1 has associated with it a set of device-specific and/or mobility infrastructure-specific IT policies (and/or application assignments). See, e.g., FIG. 5B. The sales group may then simply be assigned the same chosen security level 1 and the device manager 120, by obtaining data from another source such as a mobility server, determines the device type for each user in the group and applies the IT policies specified to maintain a consistent security level for each user in the group. This feature is particularly advantageous when a member within a group changes device types. In such a situation, the user's security level may remain the same and the device manager 120 ensures that the user maintains the same or an equivalent level of security on his/her new device regardless of its type or infrastructure.

A user may be included in more than one group. In such cases, the system may determine the privileges applicable to the particular user by specifying a group dominance hierarchy where the privileges of the more dominant group overwrite less dominant group. For example, a user may be a member of an “everyone group” (e.g., least dominant group), an “executive personnel group” and a “division employee group” of the organization. The device manager 120 compares the software privileges (e.g., IT policies and/or application assignments) associated with each group determines the net resultant privileges for the individual based on group or application dominance rules. Software only provided in the less dominant group but not prohibited in the dominant group may also be provided to the user (e.g., on a rule by rule basis). In some embodiments, an administrator may specify whether the most restrictive IT policy or application assignment wins or the least restrictive wins when a user belongs to more than one group.

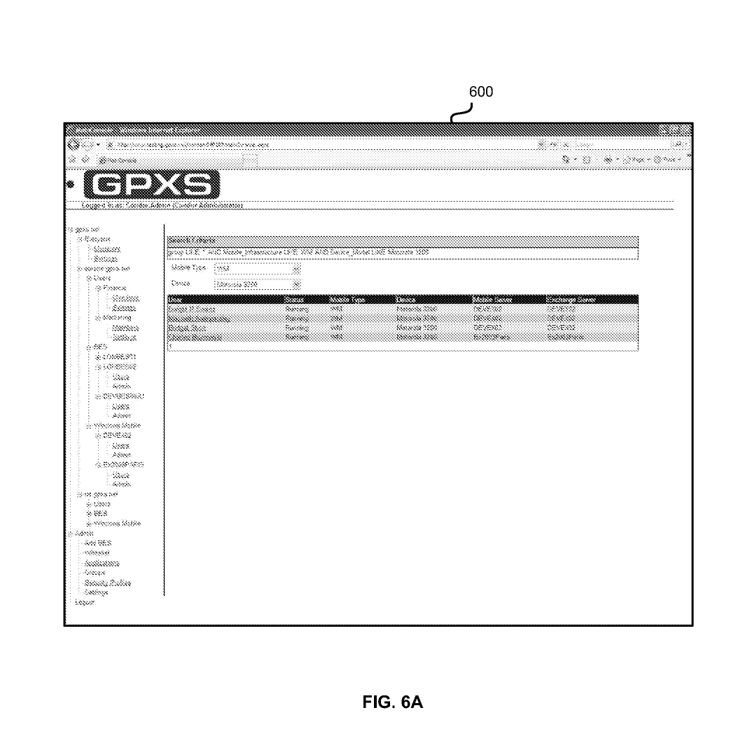

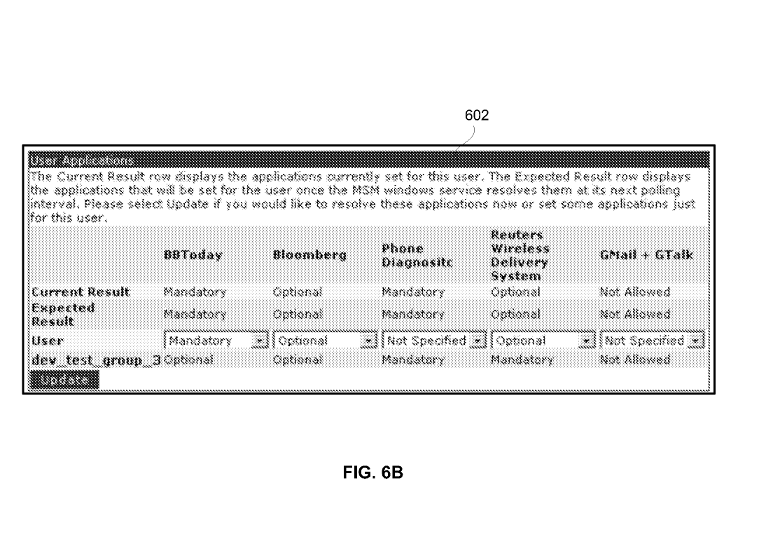

Custom privileges and policies for a specific user may further be manually specified in the manager database 121 (e.g., by a system administrator). An exemplary user interface 600 for setting custom privileges for a particular user or group of users is shown in FIG. 6B. An administrator may set a custom IT policy for a specific user irrespective of the group or groups to which he/she is a member which is more dominant than IT policies associated with groups of which the user is a member. The new IT policy may be masked if desired. The system then determines a net result set of policies or rules for each user/device. In some embodiments, the user interface of the system provides a family tree structure for viewing user groups, individuals, and the aggregated policies associated with groups and individuals. This can be audited, e.g., for regulatory compliance.

Particular policies implemented by the system according to the present invention may also pertain to particular applications in addition to groups of users. Applications may be assigned system prerequisites that must be verified before an application can be installed or removed. In some embodiments, a particular rule or administrator setting may dictate whether the most restrictive or least restrictive policy wins when there are competing policies. Device specific or application specific policies or rules may be implemented upon the registration of a new application or device, and/or stored in the manager database 121 and associated with groups or individuals to which they pertain.

An exemplary user interface 700 for registering or determining settings for an application is shown in FIGS. 7A and 7B. When an application is registered with device manager 120, an administrator is able to associate mandatory IT policy settings (e.g., enable camera) with the application. When the device manager 120 determines a net result IT policy assignments for a particular user or device, the application specific policies or settings generally override group specific policies or settings.

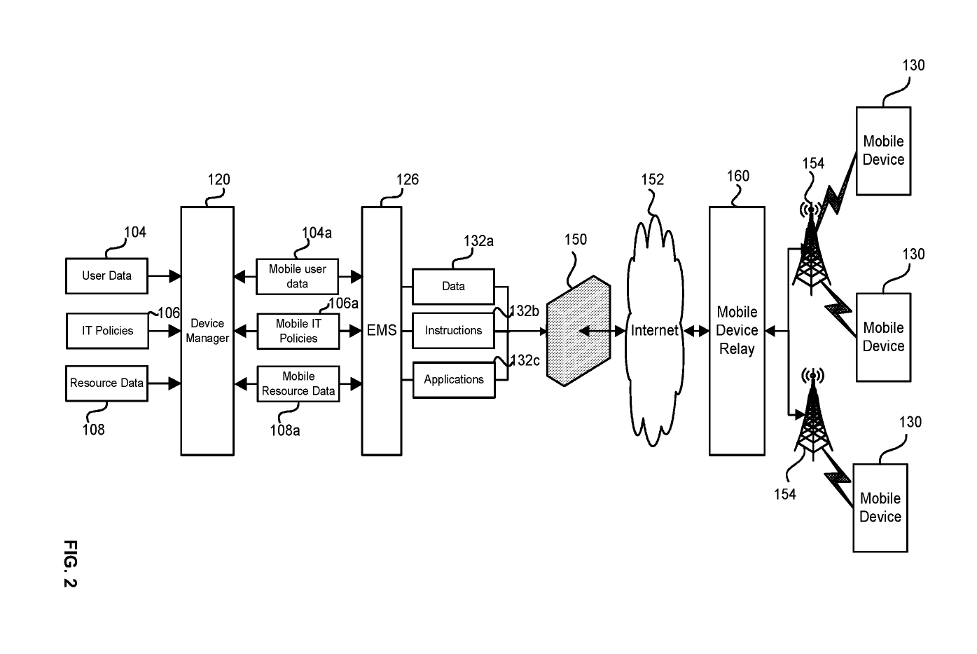

Information such as the data 132 and/or mobile applications and/or IT policies may be sent to and from the mobile devices 130 via any communication channel and/or wireless network. FIG. 2 illustrates one particular embodiment of a means to communicate the data 132 (e.g., data 132a, instructions 132b, and/or application 132c). In the exemplary embodiment, the system includes at least one separate enterprise mobility server (“EMS”) 126, e.g., residing behind the organization's firewall 150. The EMS 126 is a server for managing mobile devices, such as a BlackBerry Enterprise Server. The EMS 126 may be embodied in hardware, software or a combination of both. In larger organizations and/or organizations having multiple locations, the system may include multiple EMS's 126 (e.g., each corresponding to a group of wireless users and devices) in communication with the device manager 120.

The EMS 126 receives user data 104a and resource data 108a from the directory service 100 and/or device manager 120. In some embodiments, some of the data 104a, policies 106a, and/or resource data 108a are already stored on the EMS 126. The EMS 126 may further include status data concerning the mobile devices 130 that is accessible by the device manager 120. Information (e.g., data 132) may be pushed to one or more mobile devices 130 by the EMS 126 via the Internet 152 and/or a wireless network 154. In some embodiments, the data 132 is further sent/received via a mobile device relay 160 (e.g., Blackberry Relay). It should be understood that FIG. 2 illustrates only one exemplary embodiment, and other embodiments may not include a separate EMS 126 or a relay 160. For example, the device manager 120 may include a deployment application for communicating directly with the mobile devices 130.

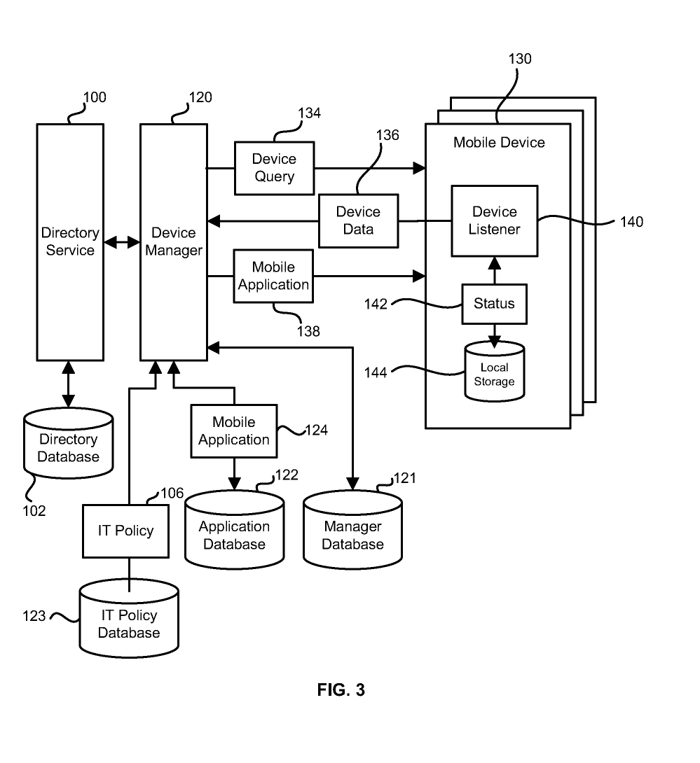

FIG. 3 shows another diagram of the system for managing applications on mobile electronic devices according to the present invention. As shown, the device manager 120 may send one or more mobile applications 138 to the mobile devices 130. For example, the device manager 120 may receive user data 104 (see, e.g., FIGS. 1-2) from the directory service 100 and data from at least one other source (e.g., policy database, mobility server) to determine a group and the privileges applicable to the group. The device manger 120 may then deploy or “push” (e.g., wirelessly) at least one mobile application 138 (e.g., executable file or other file type) to one or more of the plurality of mobile devices 130 corresponding to the group of users.

The deployment of the mobile application 138 or other electronic data to a mobile device 130 or group of mobile devices may be manually initiated, event triggered, timed or automatic. For example, the present invention provides a push throttling procedure that allows an administrator to control and configure when and at what rate (e.g., applications per mobility service per push cycle) applications are deployed and to what group or groups of users. An EMS 126 may in some embodiments limit the number of mobile devices to which an application can be deployed simultaneously (e.g., 500). Using the present invention, an administrator may therefore configure an automatic deployment that begins with a first group of users in a first interval, and upon determining that the deployment has been completed and software loaded by the first group, followed by a deployment to second group in a second interval, and so on. Thus, the number of mobile devices for which an application deployment is pending at any given time will not exceed the capacity of the system and risk a system or server crash. The automatic deployment may involve one EMS 126, or multiple EMS's deploying an application simultaneously to different groups of users.

The push throttling procedure may be initiated, e.g., by the generation of a configuration file. For example, an administrator may provide configuration data 113 via the user interface from which a configuration file is generated and implemented. Configuration data 113 may further include additions to modifications to user groups, individuals, and/or the rules related thereto.

In some embodiments, each of the mobile devices 130 may include a device agent 140 or device agent software for communicating with the device manager 120 and performing certain functions on the mobile devices 130. The device agent 140 may, for example, include event detection capabilities described in commonly owned U.S. patent application Ser. No. 11/291,579 incorporated herein by reference. Communication between each device agent 140 and the device manager 120 need not rely on any specific wireless protocol (e.g., GPRS) being available and may use different protocols (e.g., SMS, MMS, etc) if necessary. In other embodiments, the devices 130 do not require a device agent 140 or other device software to communicate with the device manager 120.

Each mobile device 130, or device agent 140 thereof, may receive any number of device queries 134 or instructions from the device manager 120. For example, the device manager 120 may query the agent 140 on one or more mobile devices 130, or a mobility server, for a status 142 of the mobile device (e.g., the status of a software deployment, log files, battery strength, signal strength or roaming status, free memory space, software, files and recent usage). The agent 140 may then provide device data 136 to the device manager 120, e.g., in response to the device query 134. The device data 136 may include the status 142 and/or a report of mobile applications executing or otherwise present on the mobile device 130. The device 130 and/or device agent 140 may also send device data 136 at specified timed intervals and/or in response to an event on the mobile device 130 (e.g., a software crash or a device reboot). The device manager 120 may also generate and distribute a report on information or device data 136 received from a plurality of agents 140 (e.g., periodically or upon request).

Each device 130 and/or agent 140 may load, delete or update applications on the mobile device 130, e.g., in response to a device query 134 and/or instruction from the device manager 120. For example, the device manager 120 may send a device query or instruction 134 including details of a set of software applications that are to be wirelessly deployed to the mobile device 130 and/or each mobile device 130 pertaining to a group of users (e.g., the timing and sequence of the wireless application deployment). The agent 140 may then execute the instructions accordingly. The agent 140 may also change a setting or configuration of an application or software running on the mobile device, e.g., by request from the device manager 120, at a specified time, and/or in response to an event on the device. In some embodiments, the system may determine an appropriate time to execute instructions received from the device manager 120. For example, the device agent 140 of a particular mobile device 130 may determine that the mobile device 130 is roaming and, due to the increased cost of data transfer rates, the system (e.g., device manager 120 or device agent 140) may delay an action such as a software deployment. The determination whether it is okay to deploy an application when roaming and other such settings are specified by an administrator and/or customized settings associated with an application, all applications, a user group or named user. If a software deployment is continuously delayed (e.g., requiring multiple attempts), an alert may be generated to a system administrator.

During a deployment of information and/or an application to mobile devices 130, the system tracks status or delivery. The system determines the status the mobile application for each device 130 (e.g., continuously) and compiles a report or list of the statuses. The report automatically gives administrators insight into the progress of an application deployment. The statuses may identify, e.g., devices that have been put in a queue to receive an application, devices that have been deployed to but not yet received the application, devices that have successfully received and installed the application, and devices for which the deployment or installation has failed. Devices for which the deployment or application installation has failed may be put back in a queue of devices to receive the application again.

The system further identifies devices having trouble or failing to receive an application deployment. For example, the system may perform a failover check to determine that one or more devices (e.g., or all of the devices) are taking an unacceptably long amount of time to receive a particular application. The device manager 120 may then automatically (e.g., or upon administrator approval) execute alternate means or mechanisms to provide the application to the one more devices. For example, the system may send an email with an embedded download link to the devices, or initiate a browser push. The system then logs and/or generates a report of the alternate mechanism. Any number of failover checks may be performed. The system may also perform any number of deployment retries after failures, e.g., each using an alternate deployment mechanism. The system may further identify whether the application is functional on one or more devices.

The device 130, and/or device agent 140 thereof, may also receive one or more IT policies 106 from the device manager 120 and/or the EMS 126. The device 130 and/or agent 140 may implement the IT policy on the mobile device 130. The device 130 and/or agent 140 may also add or delete mobile software applications accordingly, or prevent a user from loading or modifying one or more mobile device settings or software applications in accordance with an IT policy or application assignment. In some embodiments, the agent 140 continuously monitors one or more mobile applications on the mobile device 130 for compliance with the IT policy or application assignment. In some other embodiments, each of the applications on the device 130 self monitor. For example, device applications may perform a health check at a set interval or upon boot-up and report any compliance or functionality issues. IT policies may also be downloaded and/or implemented by a user of the mobile device 130 or system administrator. For example, the user may be directed to take an action to implement a policy, such as access a particular URL to download a file (e.g., IT policy 106).

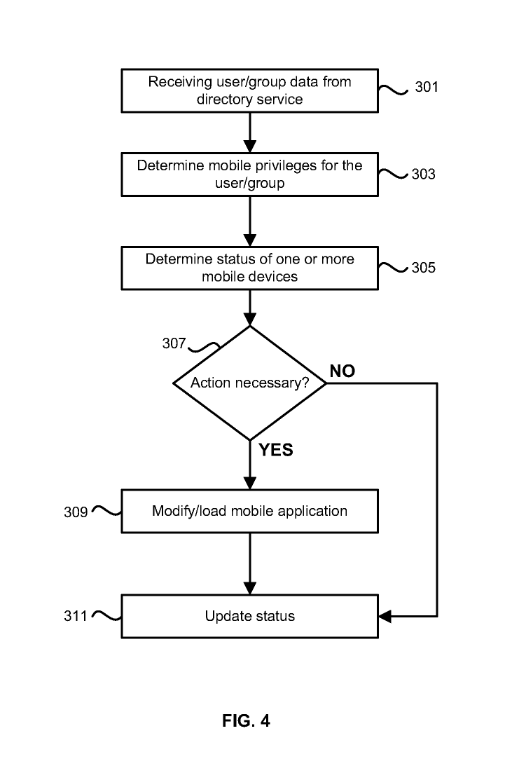

FIG. 4 shows a method for managing applications on mobile electronic devices employable by the system shown in FIGS. 1-3. The method includes a first step of receiving user data from a directory service (step 301). The user data may, for example, pertain to at least one mobile electronic device user or at least one group of users. Next, privileges are determined for the at least one user or group of users by the device manager (step 303). As discussed above, this may be done based on relationships stored in the manager database 121 and/or data obtained from various data sources (e.g., policy database 123, EMS 126, etc.)

A device status of at least one mobile electronic device corresponding to the at least one user may further be determined (step 305). The device status may be obtained by sending a device query and receiving the device status (e.g., via GPRS, SMS, or MMS) from a device agent application of each particular mobile device. In some embodiments, device statuses may also be obtained from one or more mobility servers. The device status for a particular mobile device may include data pertaining to a plurality of mobile applications operating on the particular mobile device. The device status may further include at least one of an application deployment status, a signal strength status, a memory space status, and a usage status. For example, the device status may provide information necessary to determine whether an action, e.g., mobile software change or modification, is necessary (step 307).

If an action or change is necessary, a software application is modified (e.g., loaded, updated, deleted) on one or more of the at least one mobile device corresponding to the at least one user or group of users (step 309). For example, a device manager may deploy a mobile application to one or more of the mobile devices. In some instances, the step of modifying one or more applications is performed upon a change in the software privilege data for the group of users. For example, the system according to the present invention may automatically detect changes in user or group memberships within the directory service 100 and load, update, and/or delete applications or implement IT policies accordingly. The status of each of the mobile devices may then be updated accordingly, if necessary (step 311).

Although the invention has been described with reference to a particular arrangement of parts, features and the like, these are not intended to exhaust all possible arrangements or features, and indeed many modifications and variations will be ascertainable to those of skill in the art.

What is claimed is:

1. A system for managing mobile electronic devices in a network, comprising:
a plurality of mobile electronic devices;
a directory service including user data pertaining to one or more users of said plurality of mobile electronic devices; and
a device manager for receiving the user data and determining a group of the users and at least one privilege applicable the group based on the user data and data from at least one other source;
wherein said device manager sends at least one mobile application to one or more of said plurality of mobile electronic devices based at least in part on the privilege; and
wherein said device manager comprises software for determining a status of the at least one mobile application for each of the one or more mobile electronic devices.

2. The system according to claim 1, wherein said other source includes at least one of a policy database and a device manager database.

3. The system according to claim 1, wherein the at least one privilege includes at least one application assignment and an IT policy for the group, wherein the device manager further implements the IT policy on the mobile electronic devices of the users in the group.

4. The system according to claim 1, wherein the privilege is a net resultant privilege determined based on one of a dominance of two or more conflicting privileges and a restrictiveness of the conflicting privileges.

5. The system according to claim 1, wherein each of said mobile electronic devices including a device agent for communicating with said device manager.

6. The system according to claim 1, wherein said software for determining the status receives device data from the device agent and determines the status based at least in part on the device data.

7. The system according to claim 1, wherein said software for determining the status receives device data from a mobility server and determines the status based at least in part on the device data.

8. The system according to claim 1, wherein the status is indicative of at least one of the mobile application having been sent, the mobile application having been received, the mobile application having been installed, and failed to be installed.

9. The system according to claim 1, wherein said device manager resends the mobile application to a particular one of the mobile electronic devices if a failed status is determined.

10. The system according to claim 9, wherein said device manager sends the mobile application using a first sending mechanism, and said device manager resends the mobile application using one or more second sending mechanisms.

11. The system according to claim 10, wherein the second sending mechanisms include an email including an embedded download link and a browser push.

12. The system according to claim 1, wherein said device manager sends the mobile application to a first group of the mobile electronic devices pertaining to a first group of the users, and subsequently sends the mobile application to a second group of the mobile electronic devices pertaining to a second group of users.

13. The system according to claim 12, wherein said device manager begins sending to the second group of mobile electronic devices upon determining the status for at least a portion of the first group of mobile electronic devices.

14. The system according to claim 1, wherein the at least one privilege includes data indicative of one or more mandatory mobile applications, one or more optional mobile applications and one or more prohibited mobile applications for the group of users.

15. The system according to claim 1, wherein said plurality of mobile electronic devices includes one or more devices having a first mobility infrastructure and one or more devices having a second mobility infrastructure.

16. The system according to claim 1, wherein said device manager detects at least one change in the user data and initiates at least one action based on the change.

17. The system according to claim 16, wherein said action includes at least one of sending a mobile application to at least one particular mobile device and removing a mobile application from the particular mobile device.

18. A system for managing mobile electronic devices in a network, comprising:
a plurality of mobile electronic devices;
a directory service including user data pertaining to one or more users of said plurality of mobile electronic devices;
a policy database including a plurality of policies pertaining to the mobile electronic devices;
a device manager database including data indicative of associations between the user data and the policies for one or more groups of the users;
a device manager for determining one or more policies for at least one group of the users based on the plurality of policies and the associations and implementing the one or more policies on at least one group of said plurality of mobile electronic devices; and
wherein said device manager includes a user interface for providing access to the user data and policies.

19. The system according to claim 18, further comprising an enterprise mobility server wherein said enterprise mobility server includes the policy database.

20. The system according to claim 18, wherein said user interface includes one or more reports of the status of the at least one group of said plurality of mobile electronic devices.

21. The system according to claim 18, wherein said user interface includes software for creating one or more policies for a particular mobile application.

22. The system according to claim 18, further comprising:
an enterprise mobility server for receiving at least one mobile application and deploying the mobile application to the at least one group of mobile electronic devices.

23. The system according to claim 22, wherein said user interface includes software for creating a query group comprising user data pertaining to the least one group of the users and data from said enterprise mobility server pertaining to the at least one group of mobile electronic devices.

24. The system according to claim 18, wherein said manager database further includes one or more application assignments for the one or more groups of the users, wherein said device manager further determines one or more application assignments for the group of users and sends at least one mobile application to the at least one group of mobile electronic devices based on the one or more application assignments.

25. The system according to claim 18, wherein at least one of the users is a member of two or more groups of the users, wherein said device manager determines a set of net resultant policies for the at least one user based on one of a dominance of each of the two or more groups and a restrictiveness of the policies of each of the two or more groups.
